(19) United States
(12) Patent Application Publication
(10) Pub. No.: US 2011/0274921 A1
(43) Pub. Date: Nov. 10, 2011

(54) TRIM COMPONENT AND METHOD OF EDGE FOLDING

(75) Inventors: Chi Li, Farmington Hills, MI (US); Justin Lee Healy, Canton, MI (US)

(73) Assignee: FORD GLOBAL TECHNOLOGIES, LLC, Dearborn, MI (US)

(21) Appl. No.: 12/774,095

(22) Filed: May 5, 2010

(51) Int. Cl. B32B 7/12; B32B 38/00

(52) U.S. Cl. 428/354; 156/227

(57) ABSTRACT

A trim component and method of manufacture. The trim component has thermoplastic adhesive disposed proximate an edge portion of the trim component. The adhesive melts at a higher temperature than a curing temperature of a thermoset material of the trim component.

### BACKGROUND

### Technical Field

The present invention relates to a trim component and a method of manufacturing and edge folding the trim component.

### SUMMARY

In at least one embodiment, a trim component is provided. The trim component includes a core having a thermoset material, a thermoplastic adhesive, and a backing layer. The thermoplastic adhesive is disposed along a surface of the core proximate an edge portion of the trim component. The backing layer has a first surface disposed along the thermoplastic adhesive and a second surface disposed opposite the first surface.

In at least one embodiment, a trim component is provided. The trim component includes a core, first and second thermoplastic adhesive layers, a cover layer, and a backing layer. The core has a first surface and a second surface disposed opposite the first surface. The first thermoplastic adhesive layer is disposed along the first surface proximate an edge portion of the trim component. The second thermoplastic adhesive layer is disposed along the second surface proximate the edge portion. The cover layer engages the first thermoplastic adhesive layer. The backing layer engages the second thermoplastic adhesive layer. The trim component has a fold disposed proximate the edge portion.

In at least one embodiment, a method of edge folding a trim component is provided. The method includes positioning a substrate on a first die, melting a thermoplastic adhesive layer, and folding an edge portion of the substrate to form a fold.

### BRIEF DESCRIPTION OF THE DRAWINGS

FIGS. 1 and 2 are fragmentary side views of an exemplary trim component and an edge folding apparatus.

FIG. 3 is a plan view of a portion of the edge folding apparatus without the trim component viewed from line 3-3.

FIG. 4 is a fragmentary section view of a portion of the edge folding apparatus along section line 4-4 including the trim component in the position shown in FIG. 2 prior to an edge folding operation.

FIG. 5 is a fragmentary section view of the edge folding apparatus and trim component of FIG. 4 undergoing the edge folding operation.

FIG. 6 is a magnified view of a portion of the trim component after completion of one embodiment of the edge folding operation.

FIG. 7 is a magnified view of another embodiment of a trim component after completion of an edge folding operation.

FIG. 8 is a flowchart of a method of making and edge folding the trim component.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

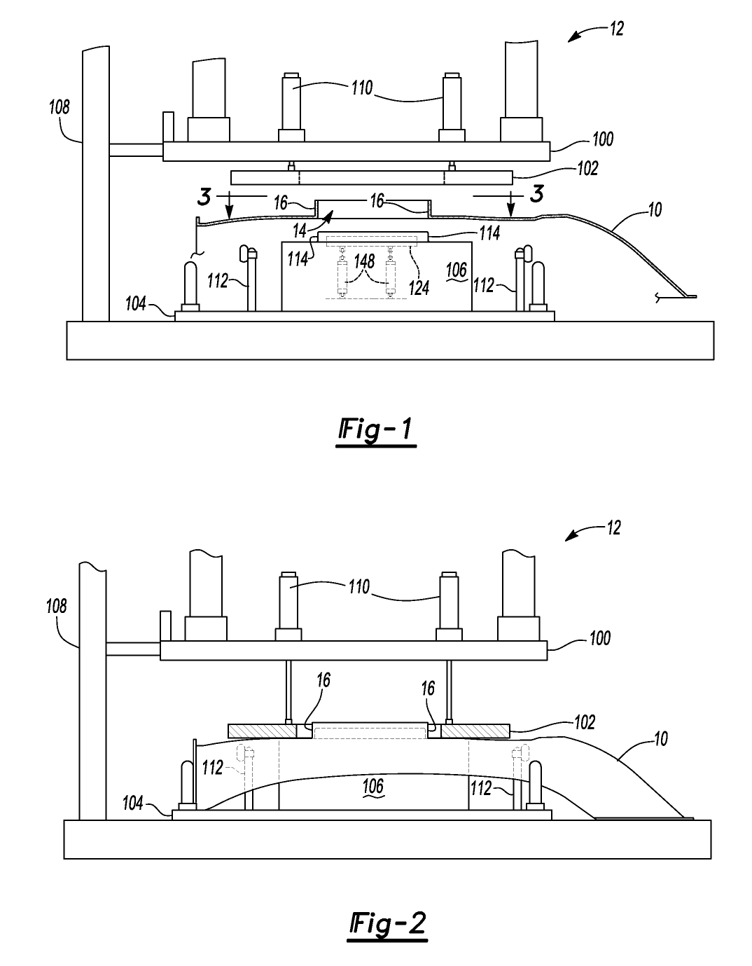

Referring to FIGS. 1 and 2, an exemplary trim component 10 and an edge folding apparatus 12 are shown. The trim component 10 may be configured as an interior trim component for a vehicle, such as a motor vehicle like a car or truck. Interior trim components may include, but not be limited to, headliners, pillar covers, door panels, trunk or storage compartment liners, or the like. In FIG. 1, the trim component 10 is configured as a headliner and has an opening 14 that may be provided for a sunroof or moonroof.

The trim component 10 may include one or more edge portions 16 or regions disposed proximate an edge of the trim component 10. An edge portion 16 may be disposed along an outer perimeter of the trim component 10 and/or along an inner perimeter of the trim component 10 when the trim component 10 has an opening 14.

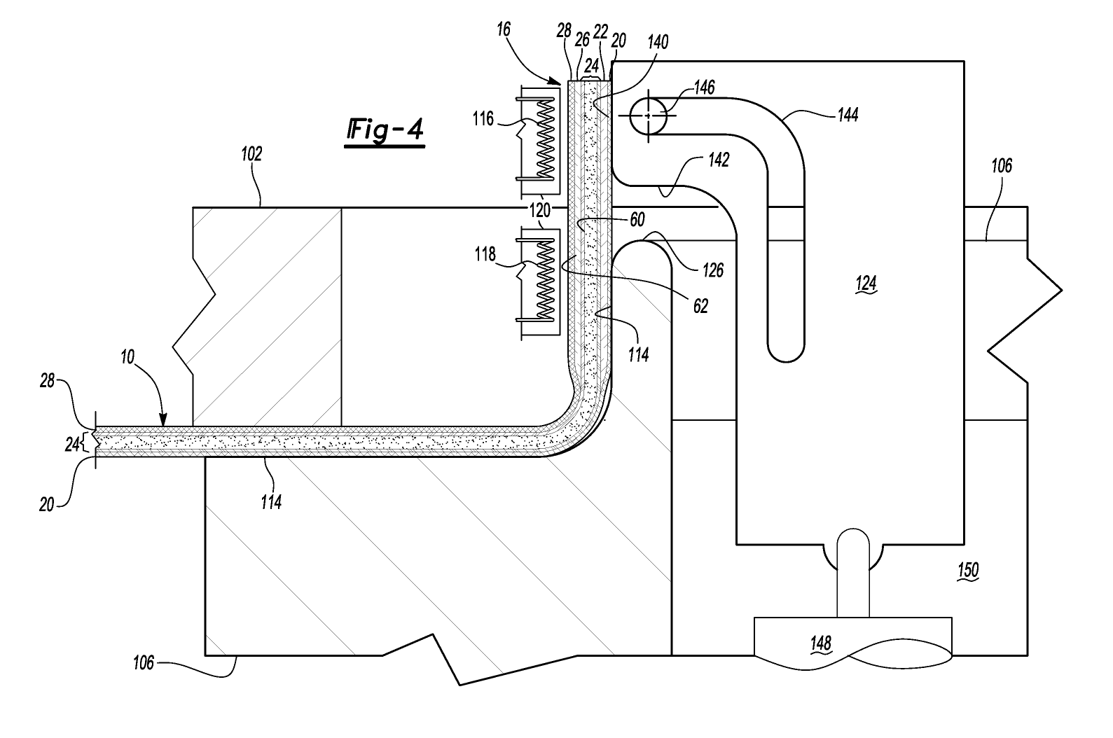

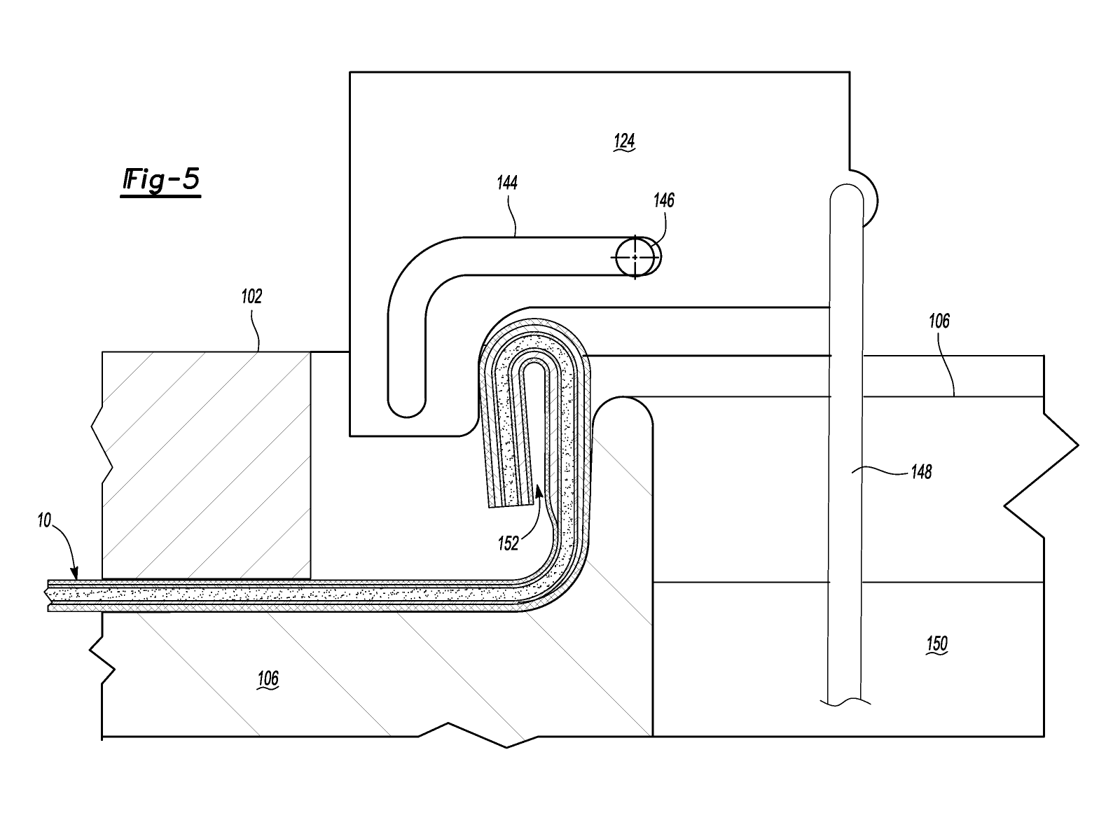

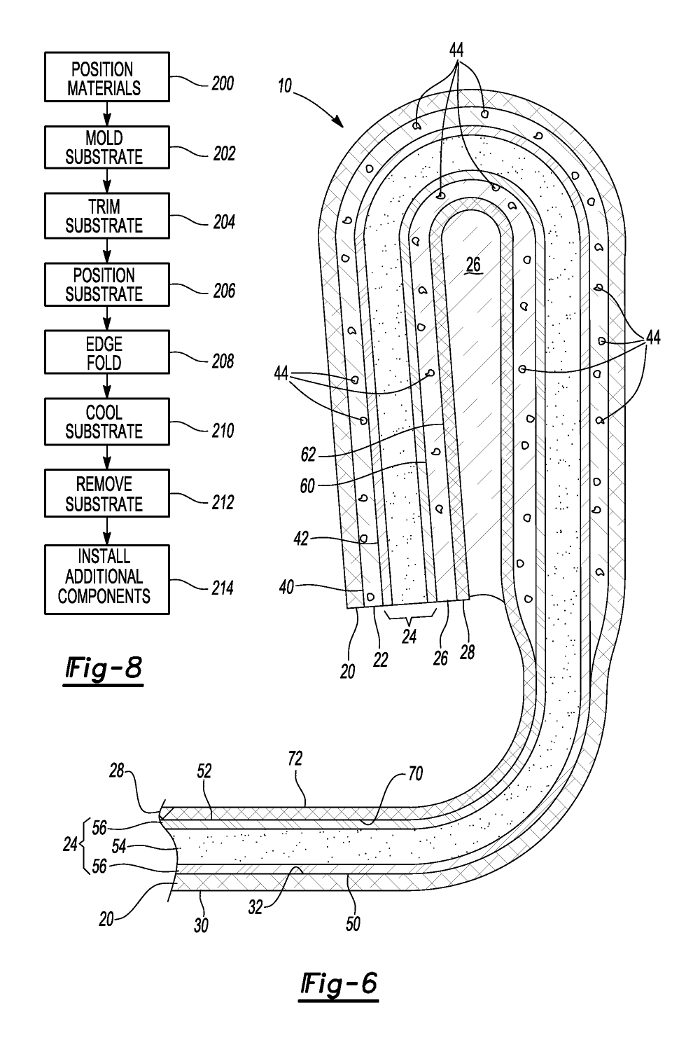

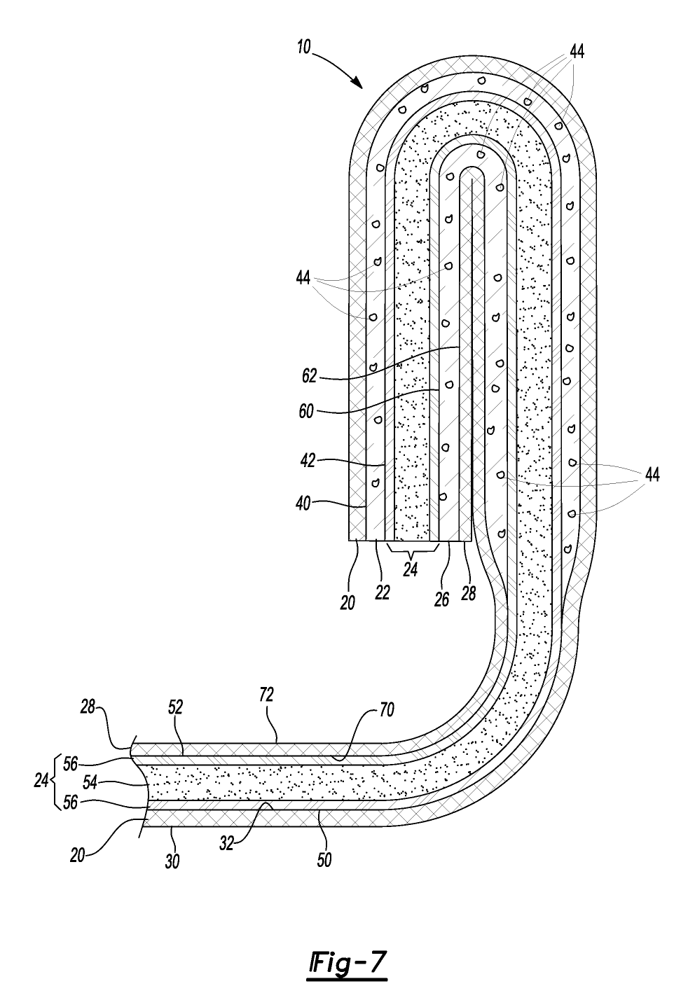

The trim component 10 may include a plurality of layers. An exemplary trim component 10 having a plurality of layers is best shown prior to folding in FIG. 4, folded but not bonded in FIG. 5, and folded and bonded in FIGS. 6 and 7. The trim component 10 may include a cover layer 20, a first adhesive layer 22, a core 24, a second adhesive layer 26, and a backing layer 28.

Referring primarily to FIGS. 4 and 6, the cover layer 20 may be provided on a visible layer of the trim component 10. The cover layer 20 may include a first surface 30 and a second surface 32 disposed opposite the first surface 30. The cover layer 20 may be made of any suitable material, such as a fabric.

An optional first adhesive layer 22 may be disposed between the cover layer 20 and the core 24. The first adhesive layer 22 may be a thermoplastic adhesive, such as a polyolefin film. The first adhesive layer 22 may include a first surface 40 and a second surface 42 disposed opposite the first surface. The first surface 40 may be disposed against or be laminated to the second surface 32 of the cover layer 20. The first adhesive layer 22 may facilitate movement of the cover layer 20 relative to the core 24 as will be described in more detail below. The first adhesive layer 22 may be locally disposed near portions or regions of the trim component 10 that will be folded, rather than as a continuous layer that extends across the entire trim component 10. For example, the first adhesive layer 22 may extend along an edge portion 16 of the trim component 10. In at least one embodiment, the first adhesive layer 22 may extend from an edge or end surface of the trim component 10 and may be disposed on opposing sides of a fold when the trim component 10 is folded. In addition, the first adhesive layer 22 may include particles 44 that may facilitate heating of the first adhesive layer 22. For instance, the particles 44 may be metallic particles that respond to energy provided by an external source, such as an inductive heating element.

The core 24 may be disposed between the cover layer 20 and the backing layer 28. The core 24 may include a first surface 50 and a second surface 52 disposed opposite the first surface 50. The first surface 50 may be disposed against or be laminated to the second surface 32 of the cover layer 20 and/or to the second surface 42 of the adhesive layer 22. The core 24 may include one or more lightweight material layers that may be porous or non-porous. For instance, a layer may be made of a polymer that irreversibly cures like a thermosetting polyurethane material layer 54 that may be a polyurethane foam. One or more reinforcement mats 56, such as fiberglass mats, may be laminated to or at least partially embedded in the polyurethane material layer 54. In the embodiment shown, a reinforcement mat 56 is disposed proximate the first and second surfaces 50, 52 of the core 24. A portion of the flexible polyurethane material layer 54 may be adhered to and/or pass through the reinforcement mat 56 to facilitate attachment of the reinforcement mat 56 to the polyurethane material layer 54. One or more reinforcement mats 56 may be omitted in various embodiments.

The second adhesive layer 26 may be disposed between the core 24 and the backing layer 28. Prior to activation, the second adhesive layer 26 may also include a first surface 60 and a second surface 62 disposed opposite the first surface 60. The first surface 60 may be disposed against or be laminated to the second surface 52 of the core 24.

The second adhesive layer 26 may be locally disposed near portions or regions of the trim component 10 that will be folded rather than as a continuous layer that extends across the entire trim component 10. For example, the second adhesive layer 26 may extend along an edge portion 16 of the trim component 10. In at least one embodiment, the second adhesive layer 26 may extend from an edge or end surface of the trim component 10 and may be disposed on opposing sides of a fold when the trim component 10 is folded.

The second adhesive layer 26 may be a thermoplastic adhesive, such as a polyolefin film. The second adhesive layer 26, as well as the first adhesive layer 22, may have a higher melting temperature than the curing temperature of thermosetting polyurethane material layer 54 to allow the polyurethane material layer 54 to be formed and cured into a desired shape and/or bond with or adhere to the reinforcement mats 56 prior to folding the trim component 10 as will be discussed in more detail below. In at least one embodiment, the melting temperature of the first and second adhesive layers 22, 26 may be approximately ten to fifteen degrees Celsius greater than the curing temperature of the polyurethane material layer 54. In addition, the second adhesive layer 26 may include particles 44 that may facilitate heating of the second adhesive layer 26. The particles 44 may be of the same type as those in the first adhesive layer 22, such as metallic particles that respond to energy provided by an external source, such as an inductive heating element.

The backing layer 28 may be provided on a back side of the trim component 10 and may generally not be visible when installed in a vehicle. The backing layer 28 may include a first surface 70 and a second surface 72 disposed opposite the first surface 70. The backing layer 28 may be made of any suitable material, such as a porous material like a fabric, felt, or non-woven material. The first surface 70 may be disposed against or be laminated to the second surface 52 of the core 24 in regions without the second adhesive layer 26 and may be disposed against or be laminated to the second surface 62 of the second adhesive layer 26 where the second adhesive layer 26 is present 24.

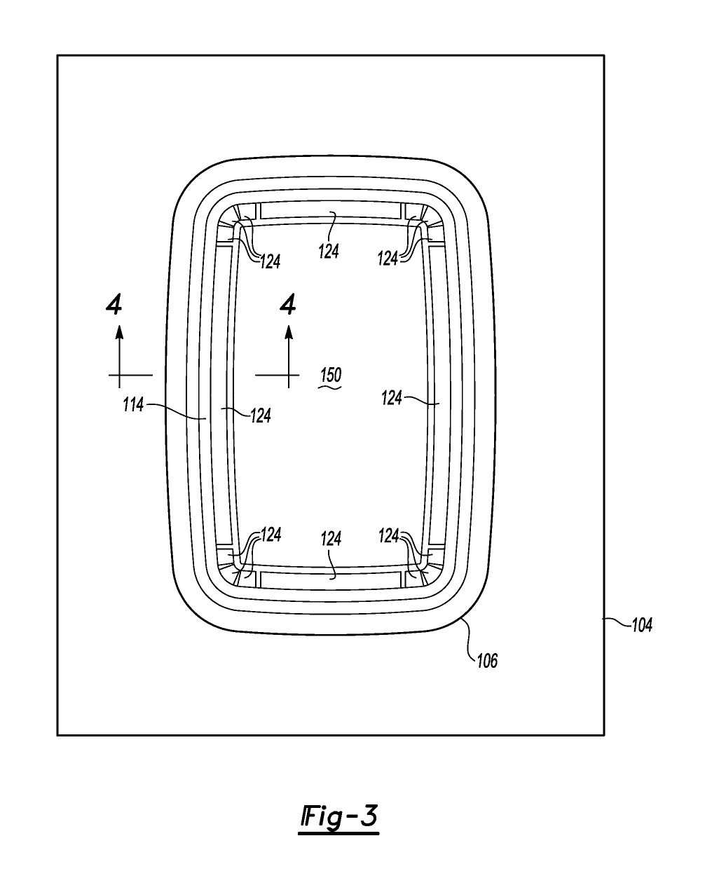

Referring again to FIGS. 1 and 2 as well as FIGS. 3 and 4, the edge folding apparatus 12 will now be described in more detail. The apparatus 12 may include a first base 100, a first die 102, a second base 104, and a second die 106. In addition, the first base 100 and second base 104 may be disposed on a structural frame 108 in one or more embodiments.

The first die 102 may be positionable with respect to the second die 106 or vice versa. In the embodiment shown in FIG. 1, the first die 102 may be moved by one or more actuators 110, such as hydraulic cylinders, that may actuate the first die 102 toward or away from the second die 106. The first die 102 may be actuated toward the second die 106 to engage and hold the trim component 10 in position during folding operations. The actuators 110 may be disposed on the first base 100. The first base 100 may be stationary or moveable. For instance, the first base 100 may be attached to a stationary structural frame in a stationary embodiment and may be attached to a moveable structural frame like a manipulator or multi-axis robot in a moveable embodiment.

The second base 104 may be a platform upon which the second die 106 and/or the trim component 10 may be disposed during assembly or forming operations. For example, the second base 104 may include one or more supports 112 that support a portion of the trim component 10.

The second die 106 may include a forming surface 114 that may be configured to shape the trim component 10.

One or more heating elements may be provided with the second die 106 and/or the first die 102. For instance, a first heating element 116 and a second heating element 118 may be provided and disposed on the same or different moveable members or slides 120 that may be disposed on the apparatus 12 as shown in FIG. 4. The slides 120 may be configured to actuate the first and/or second heating elements 116, 118 toward or in close proximity to the trim component and may be energized to heat the trim component 10. The slides 120 may be retracted to facilitate folding of the trim component 10 as will be described in more detail below.

The heating elements 116, 118 may provide energy in a manner that penetrates to the first and second adhesive layers 22, 26 without burning, damaging, or otherwise degrading other layers of the trim component 10. The heating elements 116, 118 may be of any suitable type, such as an electrical resistance heating element, inductive heating element, infrared heating element, and/or a plurality of passages that receive a heated fluid that may be provided in a manner known by those skilled in the art.

The heating elements 116, 118 may be heated to different temperatures. For instance the first heating element 116 may be heated to a higher temperature than the second heating element 118 to help insure melting in the area to be folded. In one embodiment, the first heating element 116 may be heated in a range of 10 to 50 degrees Celsius more than the second heating element 118. Optionally, a heating element may also be provided with one or more folding arms 124 that may be moveably disposed on the second die 106.

Referring to FIGS. 3 and 4, a set of folding arms 124 are provided along a top surface 126 of the second die 106 that extends from the forming surface 114. The set of folding arms 124 may be configured to move in multiple directions to fold an edge portion of the trim component 10.

As is best shown in FIG. 3, the folding arms 124 may be categorized into different subsets. A first subset of the set folding arms 124 may be disposed along the elongated sides of the second die 106 that have little or no curvature. A second subset of the set of folding arms 124 may be disposed along corners or arcs or areas of curvature of the second die 106. The folding arms 124 in the second subset may be smaller than those of the first subset to provide localized pressure and contact surface for folding the trim component 10. The folding arms 124 may be disposed generally perpendicular to at least a portion of the trim component 10 that is to be folded to provide even folding and inhibit tearing or damage to the trim component 10.

Referring to FIGS. 4 and 5, an exemplary folding arm 124 is shown in more detail. In the embodiment shown, the folding arm 124 is generally L-shaped and includes a first contact surface 140, a second contact surface 142 disposed adjacent to the first contact surface 140, and a slot 144. Alternatively, the folding arm 124 may be provided in other configurations, such as without an L-shape. For instance, the folding arm 124 may be configured as a finger or block that does not include a slot and that may be moved in multiple directions to engage and fold the trim component 10.

A guide pin 146 may be fixedly disposed on the second die 106 and may be received in the slot 144 to guide movement of the folding arm 124. An actuator 148, such as a hydraulic actuator, may be provided to actuate the folding arm 124 between a retracted position as shown in FIG. 4 and an advanced position as shown in FIG. 5. The actuator 148 may be disposed in a cavity 150 disposed in the second die 106 and may be configured to pivot with respect to the second die 106.

Referring to FIGS. 4-6, an exemplary sequence of folding steps is shown in more detail.

In FIG. 4, the trim component 10 is shown disposed between the first and second dies 102, 106. The trim component 10 may be positioned such that the cover layer 20 is disposed adjacent to the forming surface 114 of the second die 106 and adjacent to the first contact surface 140 of the folding arm 124. The edge portion 16 of the trim component 10 may overlap and engage the first contact surface 140.

After the trim component 10 is positioned, energy may be provided to heat the trim component 10. For instance, one or more heating elements 116, 118 may be positioned near the trim component 10 and may be provided energy to heat the trim component 10. The heating elements 116, 118 may be positioned with one or more slides 120 as previously described and then may be retracted to facilitate folding of the trim component 10. The energy provided may cause the first and second adhesive layers 22, 26 to melt, liquefy, or otherwise become malleable. As such, the first and/or second adhesive layers 22, 26 may provide lubricity to help allow other layers, such as the cover layer 20, core 24, and/or backing layer 28 to move or slide without tearing.

In FIG. 5, the folding arm 124 is shown actuated to the advanced position. During advancement from the retracted position to the advanced position, the slot 144 and guide pin 146 may cooperate to guide movement of the folding arm 124 such that the folding arm 124 moves in multiple or different directions to fold the trim component 10. For instance, the folding arm 124 may first advance away from the cavity 150 to begin folding the trim component. From FIG. 4 to FIG. 5, such movement is illustrated in a counterclockwise direction from the perspective shown. The folding arm 124 may change direction when the guide pin 146 moves along the curved portion of the slot 144. As such, the first contact surface 140 may begin to move downward toward a lower surface of the second die 106. The second contact surface 142 may then begin to engage and further fold the trim component 10 over itself. A gap 152 may be formed within the folded region between adjacent portions of the backing layer 28 in one or more embodiments.

Once the trim component 10 has been folded, heat and/or pressure may be applied to further shape the second adhesive layer 26 and the first adhesive layer 22, if provided. In at least one embodiment, the second adhesive layer 26 may pass through the backing layer 28 and into the gap 152 (if provided), thereby at least partially filling the gap 152 to help hold the fold together as illustrated in FIG. 6. Similarly, heating of the first adhesive layer 22 may melt or facilitate movement of the backing layer 28 over or with respect to the core 24.

Another exemplary sequence of folding steps may be provided in which the trim component 10 may be folded such that little or no gap is formed within the folded region. Such an embodiment is shown in FIG. 7. In FIG. 7, the backing layer 28 is folded against itself. As such, the trim component 10 may be positioned as described in association with FIG. 4 above. Folding may occur in a similar manner as described in association with FIG. 5, but the folding arm 124 may be configured to fold the second surface 72 against itself. Heat and pressure may then be provided as previously described.

Referring to FIG. 8 an exemplary method of fabricating a trim component 10 is shown.

At block 200, the method begins by assembling the trim component 10 layers. For instance, the cover layer 20, first adhesive layer 22, core 24, second adhesive layer 26 and backing layer 28 may be stacked or positioned in sequence with respect to each other.

At block 202, at least some of the trim component layers may be molded or laminated together. Molding or lamination may occur when heat and pressure are applied in a molding press. The heat applied may be enough to activate and cure the polyurethane material layer 54 without melting the first and second adhesive layers 22, 26. As such, the first and second adhesive layers 22, 26 may remain in a flexible but solid state.

At block 204, the trim component 10 may be trimmed to a predetermined shape. Trimming may be done in any suitable manner, such as with a blade, water jet, laser, or die-cut operation.

At block 206, the trim component 10 may be positioned in the apparatus 12 as previously described in association with FIGS. 1 and 2.

At block 208, the edge of the trim component 10 may be folded as previously described in association with FIGS. 4-7. Heat may be applied at a higher temperature than during the lamination step at block 102 to melt or liquefy the first and/or second adhesive layers 22, 26 to facilitate folding as previously discussed. The trim component 10 may be folded in a manner that hides or conceals an end surface or end cross section of the trim component 10.

At block 210, the trim component 10 may be cooled and the first and second adhesive layers 22, 26 may harden, thereby helping to secure or bond the fold. The amount of cooling time may vary depending on factors such as the characteristics of the adhesive, the thickness of the trim component layers, and the configuration of the first and second dies 102, 106. In at least one embodiment, the cooling time may be approximately 10 to 20 seconds. Cooling may also help facilitate handling of the trim component 10.

At block 212, the folding arms 124 may be returned to the retracted position and the first and second dies 102, 106 may be separated to permit the trim component 10 to be removed from the apparatus 12. Removal of the trim component 10 may be accomplished manually or with automated material handling equipment.

At block 214, additional components may be installed on the trim component 10. For example, in the case of a headliner, a reinforcement ring may be installed along the curved part of the backing layer 28 below the fold with fasteners, mounting features and sun visors may be attached, and electronic components such as lights may be installed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A trim component comprising:
a core having a thermoset material;
a thermoplastic adhesive disposed along a surface of the core proximate an edge portion of the trim component; and
a backing layer having a first surface disposed along the thermoplastic adhesive and a second surface disposed opposite the first surface;
wherein a melting temperature of the thermoplastic adhesive is greater than a curing temperature of the core.

2. The trim component of claim 1 wherein the thermoplastic adhesive passes through the backing layer to bond a fold together.

3. The trim component of claim 1 wherein a gap is created and bounded by the backing layer when the trim component is in a folded position.

4. The trim component of claim 3 wherein the thermoplastic adhesive at least partially fills the gap when the thermoplastic adhesive is melted.

5. The trim component of the claim 1 wherein the thermoplastic adhesive further comprises a plurality of metallic particles.

6. The trim component of claim 1 wherein the trim component is a headliner.

7. The trim component of claim 1 wherein an edge portion is disposed around an opening defined within the trim component and includes a fold wherein the backing layer is folded against itself.

8. A trim component comprising:
a core having a first surface and a second surface disposed opposite the first surface;
a first thermoplastic adhesive layer disposed along the first surface proximate an edge portion of the trim component;
a second thermoplastic adhesive layer disposed along the second surface proximate the edge portion;
a cover layer that engages the first thermoplastic adhesive layer; and
a backing layer that engages the second thermoplastic adhesive layer;
wherein the trim component has a fold disposed proximate the edge portion.

9. The trim component of claim 8 wherein the first and second thermoplastic adhesive layers provide lubricity to facilitate folding of the trim component.

10. The trim component of claim 8 wherein the first and second thermoplastic adhesive layers include a plurality of metallic particles that facilitate melting of the first and second thermoplastic adhesive layers.

11. A method of edge folding a trim component, comprising:
positioning a substrate on a first die, the substrate including a thermoplastic adhesive layer disposed between a backing layer and a core;
melting the thermoplastic adhesive layer; and
folding an edge portion of the substrate to form a fold.

12. The method of claim 11 wherein the step of positioning the substrate further comprises trimming the substrate before positioning the substrate.

13. The method of claim 12 wherein the step of positioning the substrate further comprises molding the substrate to a predetermined shape and curing the substrate at a first temperature before trimming the substrate.

14. The method of claim 13 wherein the first temperature is less than a second temperature that is applied to melt the thermoplastic adhesive layer.

15. The method of claim 11 wherein a gap is formed when the edge portion is folded, the gap being bounded by the backing layer.

16. The method of claim 15 wherein the thermoplastic adhesive layer passes through the backing layer to fill at least a portion of the gap when pressure and heat are applied.

17. The method of claim 11 wherein the thermoplastic adhesive layer includes metallic particles that facilitate inductive heating.

18. The method of claim 11 wherein the step of folding the edge portion further comprises actuating a folding arm outwardly from a first die in a first direction and a second direction to fold the substrate.

19. The method of claim 11 wherein the thermoplastic adhesive is at least partially melted before folding an edge portion.

20. The method of claim 11 wherein infrared heat is provided to melt the thermoplastic adhesive layer.
